(19) United States
(12) Patent Application Publication
(10) Pub. No.: US 2009/0145930 A1
(43) Pub. Date: Jun. 11, 2009

(54) WATER-SQUIRTING TOY

(76) Inventor: Willy Chen, Taipei County (TW)

Correspondence Address: Willy Chen, 235 Chung - Ho, Box 8-24, Taipei, TW

(21) Appl. No.: 11/952,149

(22) Filed: Dec. 7, 2007

(51) Int. Cl. A63H 33/00; B65D 37/00; G01F 11/00

(52) U.S. Cl. 222/214; 222/324; 446/473; 222/206

(57) ABSTRACT

A water-squirting toy comprises a cylinder, a handle, and a flexible bag. The bag is arranged inside the cylinder and may stretch and shrink following the handle that is pulled and pushed to absorb water or squirt water for fun at play of repeated water absorption and squirting. The water-squirting toy absorbs and squirts water by using the flexible bag that stretches and shrinks instead of a conventional piston that is jostled, so simple structure, fewer parts, lower fabrication labor hour, and fabrication cost down is achieved. Further, easy operation and higher duration are achieved. The cylinder may be made of soft material to squirt in a bending status. The handle and the cylinder may be connected and formed into a bar-shaped assembly for fun at play.

### FIELD OF THE INVENTION

This invention relates to a water-squirting toy and particularly to a water-squirting toy that may absorb or squirt water by pulling or pushing a handle for achievement of an object of amusement.

### DESCRIPTION OF RELATED ART

A conventional squirting toy, for example, disclosed in US patent No. US 2006/0060604, titled “SQUIRTING TOY”, mainly comprises a cylinder, a rod, and a piston. An outside of the cylinder is wrapped with a floating material and an inside of the cylinder is formed with a chamber; a cylindrical shaft of the rod may stretch in the chamber from a sealed end of the cylinder and repeatedly extend and contract in the chamber; the piston is sealed in the cylindrical chamber that allows the cylindrical shaft to drive and shift, water being absorbed into the chamber from a hole at a front end of the cylinder or squirted out of the chamber via the hole at the front end of the cylinder so that the rod during operation may be repeatedly pulled and pushed to absorb and squirt water again and again.

However, the water-squirting toy has the following defects in body assembly and operation.
1. The water-squirting device absorbs and squirts water by using the piston that is located in the chamber of cylinder to shift for suction and thrust. Thus, the piston and an inner wall of cylinder must keep the capability of airtight, so the floating material cannot be used and may be used to wrap around a surrounding wall of the outside of cylinder. Thus, there are more members for the entire assembly that is complicated, of which the cost is higher.
2. The piston and the inner wall of cylinder that are provided in the water-squirting device must keep the capability of airtight. Thus, once the piston is damaged or deflected, its airtight capability cannot achieved as it is originally, which leads to leakage of water when absorbed or squirted and thereby decreases the quantity of water absorbed and squirted, the fun at play being affected. Likewise, when the cylindrical shaft that collides or inadequately applies a force bends, it confronts the above-mentioned situation and even the shaft is caused to seriously rub against the sealed back end of the cylinder, thereby causing the rod to hard extend and contract and easily damaging the piston. Further, a general piston is mostly made of a colloidal substance. The colloidal substance is easily deformed and is not higher in endurance against friction leading to damage, so it confronts the above-mentioned situation after serving for a period of time.
3. When the rod of the water-squirting device is pulled outward, the sealed back end of the cylinder must generally be used to block a final stroke of the piston. The piston and the inner wall of cylinder are adhered and mounted, so the piston is easily impacted to get out of the cylinder when being excessively pulled by a user, thereby it being damaged.

Consequently, because of the technical defects of described above, the applicant keeps on carving unflaggingly through wholehearted experience and research to develop the present invention, which can effectively improve the defects described above.

### SUMMARY OF THE INVENTION

It is a main object of this invention to provide a water-squirting toy of which the assembly is expectedly simpler to reduce the labor hour and cost of fabrication, and easy operation, endurance, and more fun at play are much more expected.

To achieve above object, the present invention provides a water-squirting toy, comprising: a cylinder provided with a wall housing and a space defined inside the wall housing a handle provided with a handheld end and a thru-end that is opposite to the handheld end, the thru-end passing through the internal space from the back end of cylinder and shifting forward and backward in the internal space by means of a force applied by the handheld end; a flexible bag of which a front end is connected to a front end of the cylinder and provided with a water-squirting port and of which a back end is connected to the thru-end of handle so that the flexible bag may stretch following the is handle that shifts backward to absorb water into the internal chamber from the water-squirting port of flexible bag, and may shrink following the handle that shift forward to squirt water out of the internal chamber of flexible bag via the front-end water-squirting port.

Moreover the present invention provides a water-squirting toy, comprising: a cylinder provided with a surrounding wall, a front-end wall and a back-end wall, and an internal space defined by the surrounding wall, the front-end wall, and the back-end wall, the front-end wall being formed with a water-squirting port, the back-end wall being formed a piercing hole; a handle that is provided with a handheld end and a thru-end that is opposite to the handheld end, the thru-end passing through the internal space from the cylinder and shifting forward and backward in the internal space by means of a force applied by the handheld end; a flexible bag of which a front end is connected to a front end of the cylinder and provided with a water-squirting port and of which a back end is connected to the thru-end of handle so that the flexible bag may stretch following the handle that shifts backward to absorb water into the internal chamber from the water-squirting port of flexible bag, and may shrink following the handle that shift forward to squirt water out of the internal chamber of flexible bag via the front-end water-squirting port; and a connecting member that is separately arranged at the front end of the handheld end of the handle and at the position opposite to the back end of cylinder so as to separate the handle from the cylinder or connect the handle to the cylinder.

The water-squirting toy according to this invention is used to simplify the whole structure and reduce the labor hour and cost of fabrication, a bag is used to absorb water, reserve water, and squirt water in no consideration of leakage, and high efficiency of water absorption and squirt, farther-range squirt, and easy operation are achieved. Further, the bag may extend and contract in a defined final stroke, so it doesn't collide against a wall of the back end of cylinder, or its strength of collision may be reduced so as not to cause the wall of back end to be damaged and fall off for longer service life. Next, a wall around the cylinder may be fully made of a soft material, so the device when squirting water may be slightly bent for an effect of bent squirting and more fun at play. Besides, the cylinder may adequately be integrated with the handle by using a connecting assembly, and the device that is skillfully designed is formed into a bar and thus is provided for hit fun.

### BRIEF DESCRIPTION OF THE DRAWINGS

FIG. 1 is a schematic sectional side view illustrating a water-squirting toy according to this invention in a first embodiment, and illustrating a flexible bag that stretches;

FIG. 2 is a schematic sectional side view illustrating the water-squirting toy according to this invention in the first embodiment, and illustrating the flexible bag that contracts;

FIG. 3 is a schematic sectional side view illustrating the water-squirting toy according to this invention in a second embodiment, and illustrating the flexible bag that stretches;

FIG. 4 is a schematic sectional side view illustrating the water-squirting toy according to this invention in the second embodiment, and illustrating the flexible bag that contracts to squirt;

FIG. 5 is a 3D view of the appearances of first and second elements according to this invention as connecting members;

FIG. 5A is a view of the first element that revolves to connect to and loose from the second element according to this invention;

FIG. 6 is a sectional side view illustrating the water-squirting toy according to this invention in the second embodiment, and illustrating the cylinder is slightly bent in an initial stroke of squirting; and

FIG. 7 is a sectional side view illustrating the water-squirting toy according to this invention in the second embodiment, and illustrating the cylinder is slightly bent in a final stroke of squirting.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

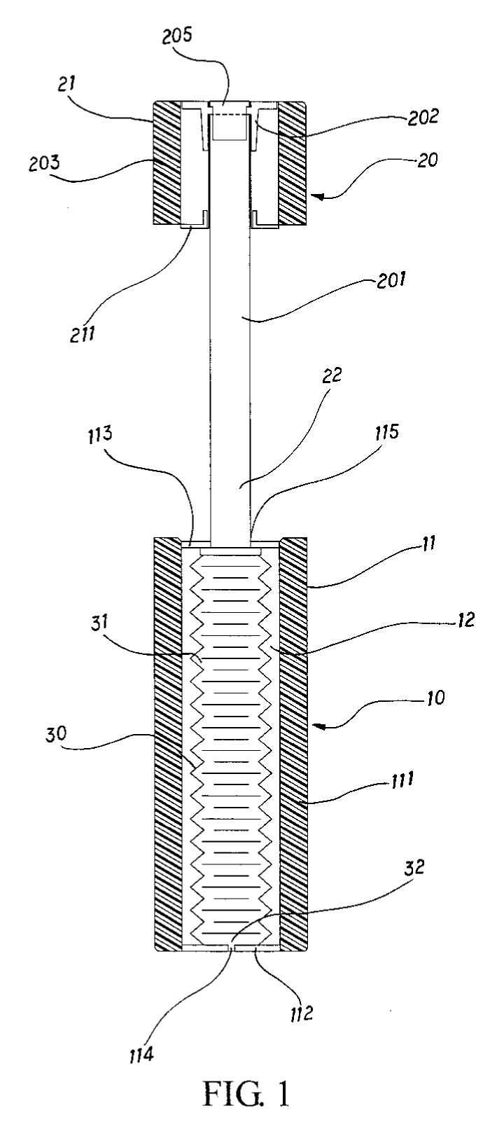

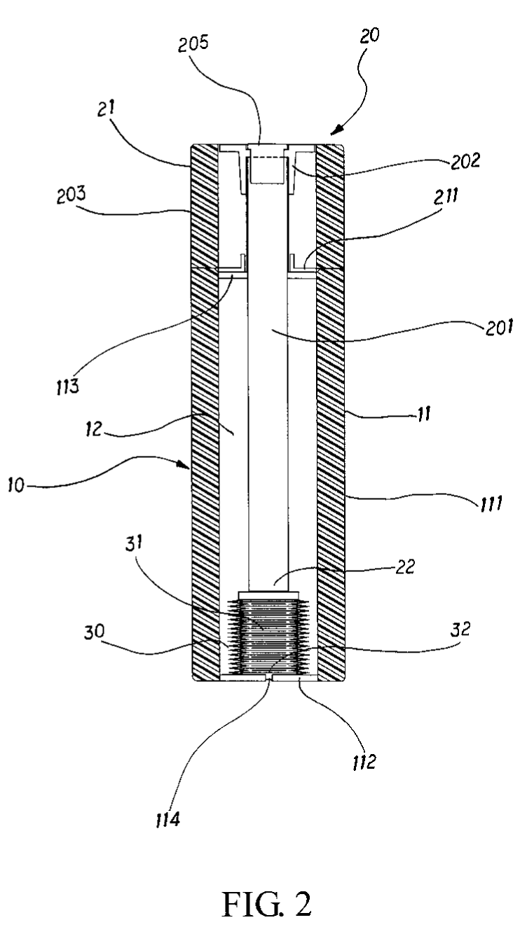

Firstly, refer to FIGS. 1 and 2 illustrating a water-squirting toy according to this invention in an embodiment, the toy comprising a cylinder 10, a handle 20, and a flexible bag 30, as described below.

The cylinder 10 is provided with a wall housing 11 and a space 12 defined inside the wall housing 11. In this embodiment, the wall housing 11 further comprises a cylindrical surrounding wall 111, a sealed front-end wall 112 that may be embedded in a front end of the surrounding wall 111, and a sealed back-end wall 113 that may be embedded in a back end of the surrounding wall 111, and an internal space may be defined by using the surrounding wall 111, the front-end wall 112, and the back-end wall 113. In the meantime, a water-through port 114 is provided in the center of front-end wall 112, while a piercing hole 115 is provided in the center of back-end wall 113. The surrounding wall 111 may be formed with a rubber or plastics as a soft material and may be adequately bent.

The handle 20 is provided with a handheld end 21 and a thru-end 22 that is opposite to the handheld end 21. The thru-end 22 may pass through the internal space 12 from the thru-hole 115 of back-end wall of the cylinder 10 and may shift forward and backward in the internal space 12 by means of a force applied by the handheld end 21. In this embodiment, the handle 20 further comprises a rod 201, a rod casing 202, and a soft rubber casing 203. The rod 201 may be made of the plastics, of which one end is used to form the thru-end 22 of the handle 20. The rod casing 202 may also be made of the plastics and its front end is provided with a blocking tablet 211 provided with a thru-hole. The rod casing 202 may embed the other end of rod 201 with a piston 205 and its thru-end 22 stretched from the thru-hole of the blocking tablet 21. The soft rubber casing 203 may be made of a rubber or plastics as a soft material and may also be made of a material equivalent to that of surrounding wall 11 of the cylinder 10, mainly being used to wrap around the wall outside the rod casing 202, thereby the handheld end 21 of the handle 20 being formed for a user to easily hold.

The flexible bag 30 is made of a rubber or plastics and thus is flexible, thereby a chamber 31 as a capacity being formed inside that may stretch and contract. In the meantime, the front end of flexible bag 30 is connected and fixed to the front-end wall 112 of the cylinder 10, and a water-squirting port 32 is provided in the center to communicate with the water-through port 114 of the front-end wall 112; the back end of flexible bag 30 is connected and fixed to the thru-end 22 of the handle 20 so that the flexible bag 30 may stretch or contract following the handle 20 that is pulled or pushed for a vacuum suction or thrush.

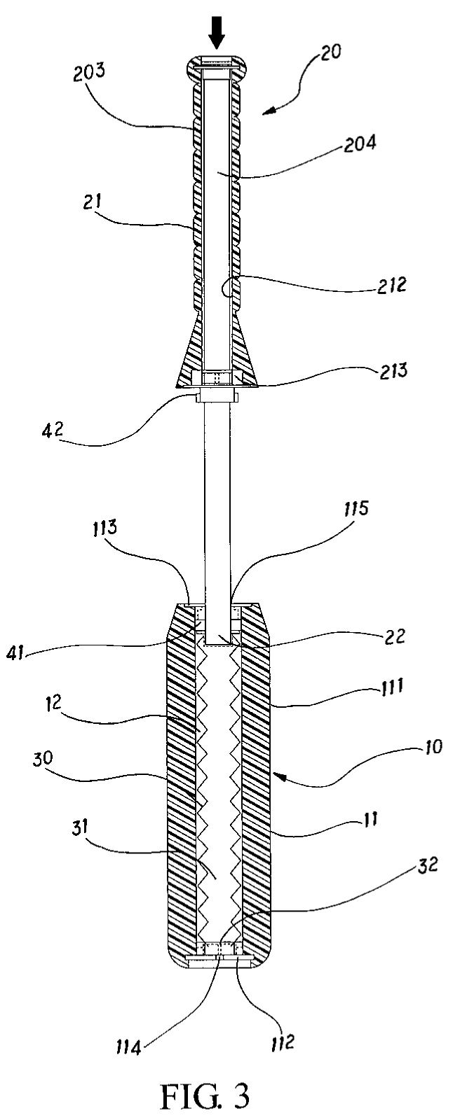

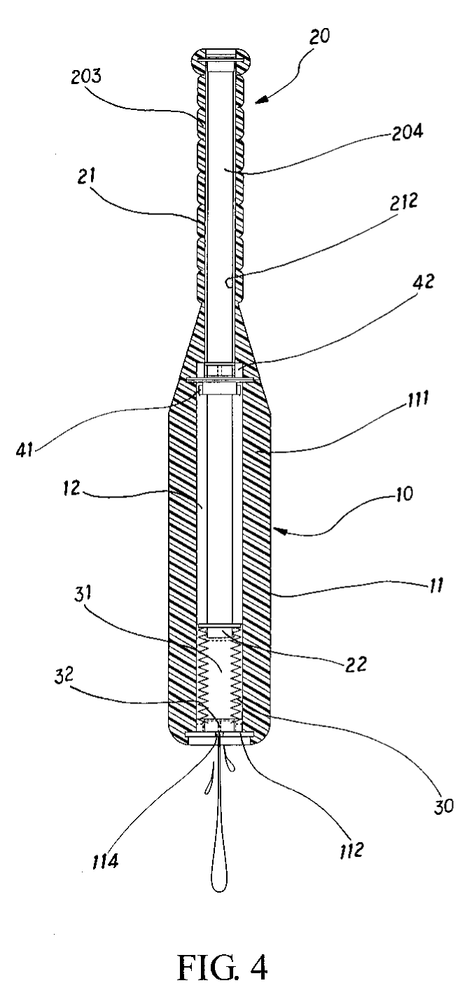

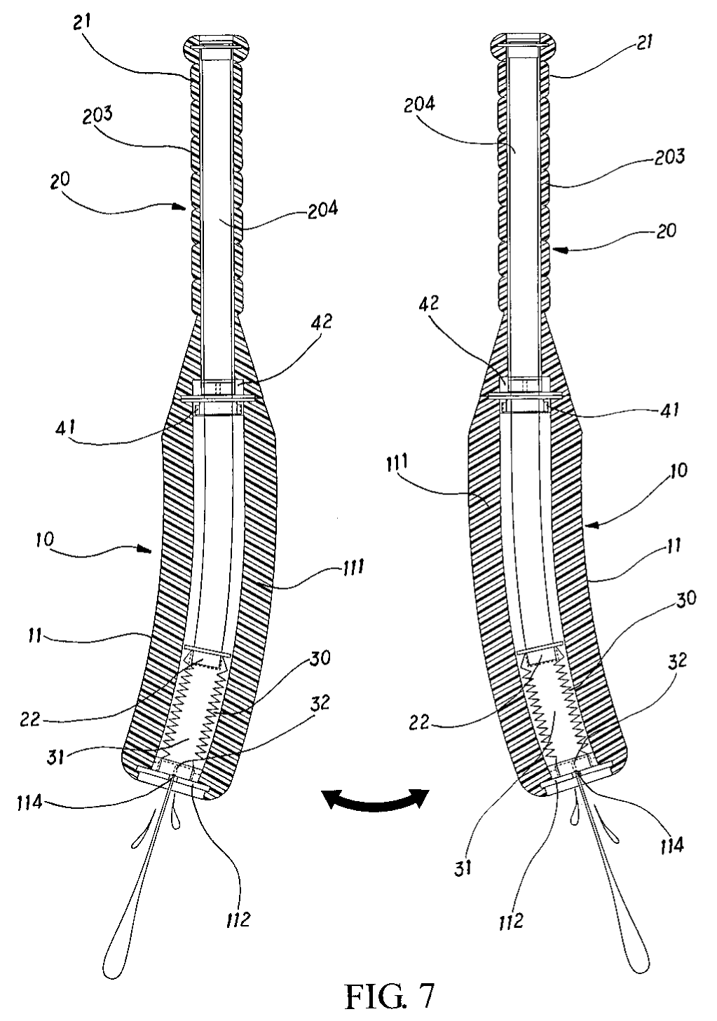

With reference to FIG. 3 through FIG. 5, in a second embodiment of this invention, an advanced assembly is provided, a connecting member 40 is added between the cylinder 10 and the handle 20. The connecting member 40 may be connected magnetically, spirally, or mechanically. In this embodiment, the mechanical connection is applied and the structure comprises a first element 41 and a second element 42. The first element 41 is fixed to the back-end wall 113 of the cylinder 10 and provided with a thru-hole 411 allowing the thru-end 22 of handle 20 to stretch, and with an inward concave 412 around which a wall is formed with 3 buckle groove 413 in a shape of “L”. The second element 42 is fixed to a front end of the handheld end 21 of handle 20 and also provided with a thru-hole 421 allowing the handle 20 to pass through, and with a protruding portion 422 outside which a surrounding wall is formed with 3 buckle lumps 423 in a shape of “L” to respectively revolve around each of the buckle grooves 413 of the inward concave 412 of the first element 41 for buckling or loose so as to freely control the cylinder 10 to separate from or connect to the handle 20. What we especially explain is the cylinder 10 and the handle 20 according to this invention that may be skillfully designed for a structure in a form of bar, as illustrated in FIG. 4. Further, in the first embodiment, the rod 201, the rod casing 202, and the blocking tablet 211 may be integrated into a rod 204 and embedded into a casing hole 212 of the soft rubber casing 203 for a simplified structure. Next, the rod 204 may also be slightly bent adapt to the cylinder 10, as shown in FIG. 7. Again, a groove 213 is provided at a front end of the soft rubber casing 203 for the second element 42 to be embedded.

Refer to again FIGS. 1 and 2 illustrating the water-squirting toy in the first embodiment; when the toy is operated, the handle 20 may be pushed forward to make the flexible bag 30 to be compressed. Next, only the water-through port 114 at the front end of the cylinder 10 is made to contact a water-drawn region or soak in the region, and then the handle 20 is pulled backward to make the flexible bag 30 stretch by degrees so that the vacuum suction is generated to make water to be absorbed into the internal chamber 31 by degrees from the water-through port 114 of the front-end wall 112 of cylinder 10 via the water-squirting port 32 of the flexible bag 30 until the flexible bag 30 stretches to a maximum stroke and the chamber 31 is with water. At this time, the water-thru port 114 at the front end of the cylinder 10 may be made to leave from the water-drawn region, and targets an object or a direction to squirt water. Next, the handle 20 is pushed forward with a force to compress the flexible bag 30 by degrees, in which the compressive force may drive water reserved in the chamber 31 of flexible bag 30 to be squirted out of the water-squirting port 32 at the front end via the water-thru port 114 of the cylinder 10 in a predetermined direction or towards an object for fun at play.

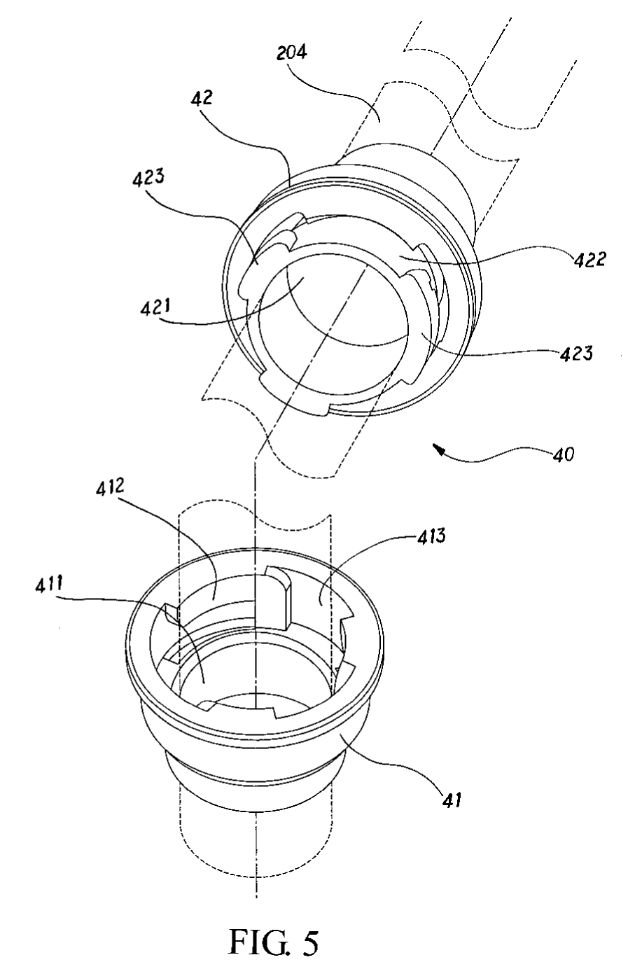

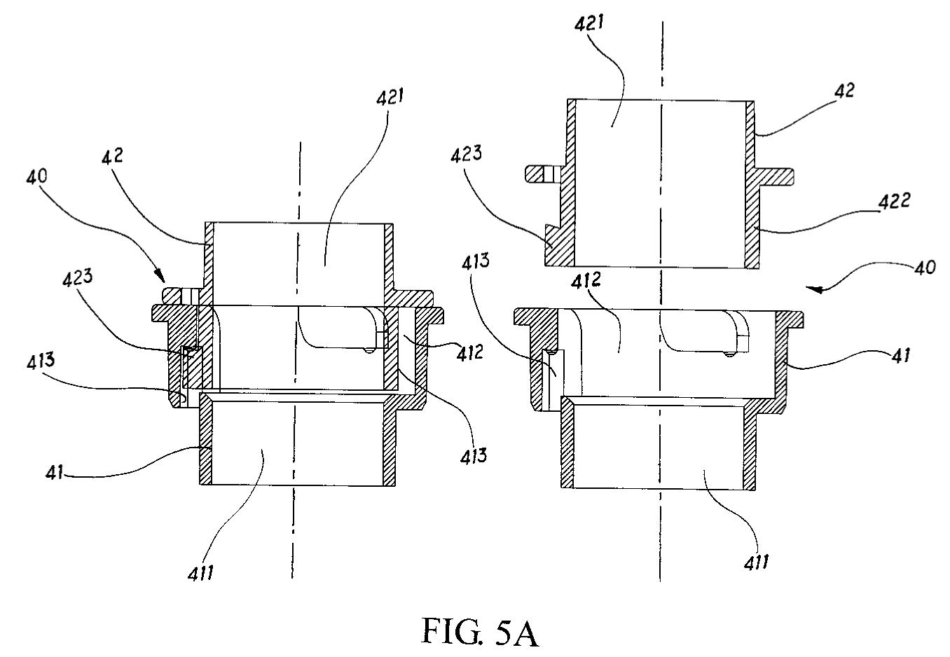

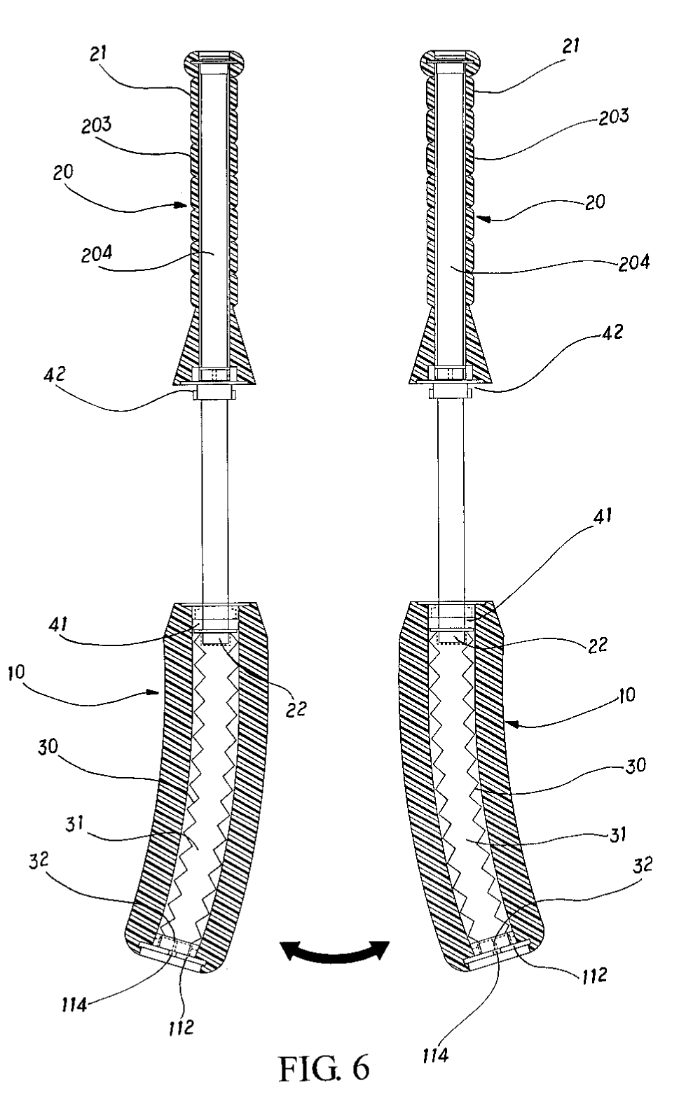

With reference to FIGS. 3 and 4, the way of operation of the water-squirting toy according to this invention in the second embodiment is mostly equivalent to that in the first embodiment, the two embodiments being different from each other in that the connecting member 40 is added between the handle 20 and cylinder 10 of the water-squirting toy in the second embodiment, as shown in FIGS. 5 and 6, in which the first element 41 and second element 42 of the connecting member 40 are separate, the handle 20 may be pulled and pushed to absorb and squirt water. Besides, when the first element 41 and the second element 42 revolve to buckle each other, the handle 20 and the cylinder 10 may buckle with and connect to each other to form a structure in a form of bar so as to hit for fun, as shown in FIG. 4, in which the soft rubber casing 203 of handle 20 and the cylinder 10 may be designed with a soft material, so safety is assured during hit for fun.

Regarding the water-squirting toy according to this invention, in both the first embodiment and the second embodiment, the surrounding wall of the cylinder 10 may be made of the rubber or plastics as the soft material, so adequate flexibility is given and the rods 201 and 204 of the handle 20 may be flexibly bent within limit. Thus, even if the cylinder 10 is slightly bent, the handle 20 may smoothly pull and push the flexible bag 30 to absorb and squirt water. In other words, the user may also skillfully bend the cylinder 10 in a predetermined direction for achievement of the special effect of water squirting in the bending status for fun at play, as shown in FIGS. 6 and 7.

From the description made above, the features and virtues of the invention that may be achieved are arranged below.
1. Compared with the conventional water-squirting toy, the water-squirting toy according to this invention is structured with no piston and the surrounding wall 111 of the cylinder 10 may be purely made of the soft material, thereby simple structure, fewer parts, lower fabrication labor hour, and fabrication cost down being achieved.
2. The toy according to this invention generally uses the flexible bag 30 that may stretch and shrink to absorb, reserve, and squirt water, so friction, damage, and leakage caused by the shift of piston does not a bit happen during operation; thus, higher efficiency of water absorption, reservation, and squirt, farther-range squirt, higher durability, and even easy operation are achieved.
3. The flexible bag 30 of water-squirting toy according to this invention is limited in a length of stretch and shrinkage so as to limit the stroke of pull and push; thus, the collision against the back-end wall 113 of cylinder 10 that is caused by the outward pull of the handle 20 may be avoided, or the strength of force is adequate is reduced to avoid the damage and loose that is caused by the collision of back-end wall 113, thereby the service life of cylinder 10 being prolonged.
4. The wall around the cylinder 10 of the water-squirting toy according to this invention may be fully made of the soft material, so the device when squirting water may be slightly bent and the rods 201 and 204 of the handle 20 may be flexibly bent within limit and the special effect of water squirting in the bending status may be achieved for more fun at play.
5. The connecting member 40 may be added between the cylinder 10 and handle 20 of the water-squirting toy according to this invention, and the handle 20 and the cylinder 10 may revolve to buckle with and connect to each other to form a structure in a shape of bar and thus the object of hit for fun may be given; further, the soft rubber casing 203 of handle 20 and the cylinder 10 may be made of the soft material, so safety is assured during hit for fun.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A water-squirting toy, comprising:
a cylinder provided with a wall housing and a space defined inside the wall housing;
a handle provided with a handheld end and a thru-end that is opposite to the handheld end, the thru-end passing through the internal space from the back end of cylinder and shifting forward and backward in the internal space by means of a force applied by the handheld end;
a flexible bag of which a front end is connected to a front end of the cylinder and provided with a water-squirting port and of which a back end is connected to the thru-end of handle so that the flexible bag may stretch following the handle that shifts backward to absorb water into the internal chamber from the water-squirting port of flexible bag, and may shrink following the handle that shift forward to squirt water out of the internal chamber of flexible bag via the front-end water-squirting port.

2. The water-squirting toy according to claim 1, wherein the housing wall of cylinder further comprises a surrounding wall, a front-end wall, and a back-end wall and the surrounding wall, the front-end wall, and the back-end wall may be used to define the internal space.

3. The water-squirting toy according to claim 2, wherein the front-end wall of cylinder is connected and fixed to the front end of flexible bag.

4. The water-squirting toy according to claim 2, wherein the front-end wall of cylinder is further provided with a water-thru port to communicate with the water-squirting port of flexible bag.

5. The water-squirting toy according to claim 2, wherein the back-end wall of cylinder is further provided with a piercing port to which the thru-end of handle may stretch.

6. The water-squirting toy according to claim 1, wherein the handle further comprises a rod, a rod casing, and a soft rubber casing, one end of the rod being formed into a thru-end of the handle, the other end being embedded together with the rod casing, and the soft rubber casing wrapping around the wall outside the rod casing to form a handheld end of the handle.

7. The water-squirting toy according to claim 1, wherein the handle further comprises the rod and the soft rubber casing, one end of the rod being formed into the thru-end of the handle, and the other end being embedded together with the soft rubber casing to form the handheld end of the handle.

8. The water-squirting toy according to claim 6, wherein the rod is made of plastics.

9. The water-squirting toy according to claim 6, wherein the rod casing is made of plastics.

10. The water-squirting toy according to claim 6, wherein the wall around the cylinder is made of a soft material.

11. The water-squirting toy according to claim 1, wherein it comprises connecting members that are separately arranged at a front end of the handheld end of the handle and a position opposite to the back end of cylinder so as to separate the handle from the cylinder or connect the handle to the cylinder.

12. The water-squirting toy according to claim 11, wherein the connecting member further comprises a first element and a second element; the first element is arranged in and fixed to the back end of the cylinder and is provided with a thru-hole allowing the thru-end of handle to stretch, and with an inward concave around which a wall is formed with at least one buckle groove in a shape of “L”; the second element is fixed to a front end of the handheld end of handle and provided with a protruding portion outside which a surrounding wall is formed with at least one buckle lump in a shape of “L” to respectively revolve around the buckle grooves of the inward concave of the first element for buckling or loose.

13. A water-squirting toy, comprising:
a cylinder provided with a surrounding wall, a front-end wall and a back-end wall, and an internal space defined by the surrounding wall, the front-end wall, and the back-end wall, the front-end wall being formed with a water-squirting port, the back-end wall being formed a piercing hole;
a handle that is provided with a handheld end and a thru-end that is opposite to the handheld end, the thru-end passing through the internal space from the cylinder and shifting forward and backward in the internal space by means of a force applied by the handheld end;
a flexible bag of which a front end is connected to a front end of the cylinder and provided with a water-squirting port and of which a back end is connected to the thru-end of handle so that the flexible bag may stretch following the handle that shifts backward to absorb water into the internal chamber from the water-squirting port of flexible bag, and may shrink following the handle that shift forward to squirt water out of the internal chamber of flexible bag via the front-end water-squirting port; and
a connecting member that is separately arranged at the front end of the handheld end of the handle and at the position opposite to the back end of cylinder so as to separate the handle from the cylinder or connect the handle to the cylinder.

14. The water-squirting toy according to claim 13, wherein the connecting member further comprises a first element and a second element; the first element is arranged in and fixed to the back end of the cylinder and is provided with the thru-hole allowing the thru-end of handle to stretch, and with the inward concave around which the wall is formed with at least one buckle groove in a shape of “L”; the second element is fixed to the front end of the handheld end of handle and provided with the protruding portion outside which the surrounding wall is formed with at least one buckle lump in the shape of “L” to respectively revolve around the buckle grooves of the inward concave of the first element for buckling or loose.

15. The water-squirting toy according to claim 13, wherein the handle further comprises the rod and the soft rubber casing, one end of the rod being formed into the thru-end of the handle, and the other end being embedded together with the soft rubber casing to form the handheld end of the handle.
